(19) United States
(12) Patent Application Publication
(10) Pub. No.: US 2026/0347018 A1
(43) Pub. Date: Nov. 5, 2026

(54) SYSTEMS AND METHODS FOR ONE-WAY DRONE DELIVERY

(71) Applicant: VIRGINIA TECH INTELLECTUAL PROPERTIES, INC., Blacksburg, VA (US)

(72) Inventor: Matthew William Baker, Blacksburg, VA (US)

(21) Appl. No.: 19/665,741

(22) Filed: May 1, 2026

Related U.S. Application Data
(60) Provisional application No. 63/798,039, filed on May 1, 2025.

(51) Int. Cl. B64U 20/70; B64U 10/25; B64U 20/60; B64U 20/80; B64U 30/40; B64U 50/13; B64U 101/64

(52) U.S. Cl. CPC B64U 20/70; B64U 10/25; B64U 20/60; B64U 20/80; B64U 30/40; B64U 50/13; B64U 2101/64

(57) ABSTRACT

Various examples are provided related to unmanned aerial vehicles (UAVs) and drones that can be used for payload delivery. In one example, a UAV or drone includes an electronics circuit module including a motor, flight controller, and power source; an airframe formed from flat sheet stock materials including cuttings and pre-formed fold lines; and a wing assembly affixed to the airframe; where the airframe and wing assembly can provide for one-way flight from a launch point to a delivery point. The wing assembly includes a wing formed from flat sheet stock materials. The airframe is folded along the fold lines and about the electronics circuit module thereby removably housing the electronics circuit module within a front portion of the airframe.

### CROSS REFERENCE TO RELATED APPLICATIONS

This application claims priority to, and the benefit of, U.S. provisional application entitled “Systems and Methods for One-Way Drone Delivery” having Ser. No. 63/798,039, filed May 1, 2025, which is hereby incorporated by reference in its entirety.

### BACKGROUND

Conventional drone delivery platforms impose high capital expenditure on the delivery of low-margin goods. Existing platforms are engineered as reusable aerospace vehicles that must fly a round trip for every delivery, requiring battery capacity for the complete return journey, recovery infrastructure at the origin point, and per-unit platform costs in the range of thousands to tens of thousands of dollars. The original Zipline concept recognized the advantage of fixed-wing flight over rotorcraft for range and simplicity; however, even Zipline and similar platforms (Alphabet Wing, Amazon Prime Air) have converged on increasingly complex VTOL rotorcraft hybrid designs that require substantial ground infrastructure and per-unit capital investment. For a platform delivering low-value consumer goods, the return on investment may require thousands of revenue-generating flight cycles per airframe to amortize hardware capital expenditure alone, before accounting for the fixed ground infrastructure investment in automated docking, charging, and distribution facilities. This ground infrastructure further constrains design iteration: because the airframe must remain compatible with existing ground stations, fundamental design changes propagate through the entire deployed infrastructure, slowing the rate at which the platform can evolve.

### SUMMARY

Aspects of the present disclosure are related to unmanned aerial vehicles (UAVs) and delivery drones. A fixed-wing unmanned aerial vehicle for one-way payload delivery can comprise an airframe formed from flat sheet stock material using converting operations including cutting and folding along pre-formed fold lines. The vehicle employs a two-tier component architecture separating an expendable airframe from optionally recoverable electronics circuit module(s) removably housed within the airframe. The one-way flight profile can optimize vehicle mass, battery capacity, and cost for the delivery leg while electronics circuit module(s) can be returned separately via ground transportation. The manufacturing method is compatible with packaging industry converting equipment at production rates of hundreds of airframes per hour.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate examples of an airframe and electronics circuit module of an unmanned aerial vehicle (UAV) or drone, in accordance with various embodiments of the present disclosure.

FIG. 2 illustrates cross-sectional views of examples of wing profiles, in accordance with various embodiments of the present disclosure.

FIG. 3 is an image showing a whippletree load distribution test on a corrugated flat plate wing, in accordance with various embodiments of the present disclosure.

FIGS. 4A-4B illustrate examples of airfoil profile overlay and wing profile progression, in accordance with various embodiments of the present disclosure.

FIGS. 4C-4D illustrate examples of lift-to-drag (L/D) polar comparison at Re=60,000 and peak L/D vs. Reynolds number comparison across Re=40,000-120,000, in accordance with various embodiments of the present disclosure.

FIG. 4E illustrates an example of wing leading edge crush detail, in accordance with various embodiments of the present disclosure.

FIG. 5 is a flow diagram illustrating an example of a delivery method, in accordance with various embodiments of the present disclosure.

FIGS. 6A-6E illustrate a fabricated example of the UAV or drone of FIGS. 1A and 1B, in accordance with various embodiments of the present disclosure.

FIGS. 7A-7D and 8A-8C illustrate examples of UAVs or drones, in accordance with various embodiments of the present disclosure.

### DETAILED DESCRIPTION

Disclosed herein are various examples related to unmanned aerial vehicles (UAVs) and delivery drones. The present disclosure relates to UAVs for payload delivery, and to manufacturing methods for autonomous fixed-wing aircraft incorporating corrugated paperboard construction and packaging industry converting processes. Reference will now be made in detail to the description of the embodiments as illustrated in the drawings, wherein like reference numbers indicate like parts throughout the several views.

The present disclosure reframes this problem from first principles: if the delivery leg is what generates revenue, and the airframe is the cheapest component, why optimize for reuse?Instead, make the airframe so inexpensive that one-way flight is economically rational. The expensive electronics circuit module(s) can be returned later via low-cost ground shipping. The consumer pays for fast delivery, not fast return. This asymmetric optimization eliminates return flight battery capacity, recovery infrastructure, and the engineering complexity of a vehicle that must survive hundreds of flight cycles.

Existing low-cost approaches do not solve this problem. Hobby radio controlled (RC) construction (SYPAQ-type systems) uses laser-cut foam sheet manually assembled with adhesives and rubber bands, requiring approximately 60 minutes of semi-skilled labor per unit. These methods cannot scale to industrial production volumes. More advanced military disposable systems (Silent Arrow, DARPA APSARA) are unpowered gliders requiring mothership deployment via transport aircraft, making them unsuitable for distributed ground-based logistics. All existing fixed—wing drone platforms-whether reusable or disposable—are designed and built by aerospace engineers using aerospace methods: carbon fiber, molded foams, composite layup, or CNC-routed structures. These processes are fundamentally artisanal, generate non-recyclable waste, and cannot leverage existing industrial manufacturing infrastructure.

No existing system applies high-volume packaging industry converting methods-such as rotary die-cutting, case erecting, and folder-gluing—to aircraft manufacturing. The convergence of corrugated paperboard construction, packaging industry equipment compatibility, powered autonomous flight capability, and selective electronics payload recovery remains unaddressed. The proposed methodology addresses this gap by relocating drone manufacturing from aerospace facilities to corrugated converting lines, leveraging decades of existing commercial infrastructure designed for high-volume production of corrugated packaging.

The present disclosure presents a fixed-wing autonomous aerial vehicle with an airframe manufactured from corrugated paperboard using packaging industry converting equipment. The vehicle is designed for single-use delivery missions with optional selective recovery of the electronics circuit module(s). The two-tier architecture separates the expendable airframe (wing, fuselage, stabilizer) from recoverable electronics circuit module(s) (flight controller, power unit, battery, servos).

Manufacturing can employ standard converting operations: rotary die-cutting to cut component blanks from flat sheet stock, scoring to define fold lines, and folding to create three-dimensional structures. Component blanks are bonded with adhesives compatible with paper recycling, assembled into a flight-ready configuration on the order of minutes. The production machine may have integrated launching. The drone can be operated autonomously to deliver payload to a pre-programmed location though specialty applications can leverage first person view (FPV) or other guidance systems.

Innovations include: (1) Manufacturing method leveraging existing converting equipment and production infrastructure; (2) Integrated electronics payloads permitting selective recovery independent of airframe expendability; (3) Flat plate airfoil optimized for low Reynolds number operation with zero additional shaping operations needed, with optional enhanced profiles achievable through converting-compatible score lines and leading edge crush treatment; (4) Integration with commercial paperboard recycling streams for end-of-life material recovery. The system is designed for rapid industrial production at rates compatible with commercial packaging converting equipment, enabling cost-effective deployment for autonomous delivery applications.

The scalability of the one-way delivery architecture enables deployment across multiple market segments at different platform sizes such as, e.g.:
First Responder and Medical Delivery: Small-format platforms (Martin class, <250 g payload) deliver EpiPens, blood products, antivenom, naloxone, and other time-critical medical supplies to locations inaccessible by ground vehicle. The expendable airframe can eliminate recovery logistics in emergency scenarios. Platform cost is a fraction of the payload value.
Consumer Last-Mile Delivery: Mid-format platforms (Mallard class, <450 g payload, approximately 500 mL capacity) serve ecommerce delivery applications. The one-way architecture reflects the economic asymmetry of consumer delivery: the consumer pays for fast delivery, not fast return. Electronics circuit module(s) can be recovered via low-cost ground shipping (mail, retail return point) at a longer time horizon. Airframe enters the consumer's existing paper recycling stream.
Military Training and Tactical Resupply: Both small and mid-format platforms provide expendable delivery of ammunition, medical supplies, communications equipment, and training targets. In training applications, the platform serves as a realistic low-cost aerial target that can be engaged and destroyed without financial concern. Fully expendable mission profiles require no recovery infrastructure. The corrugated airframe has a minimal radar and infrared signature.
   The platform scales continuously from the smallest format to larger variants without changing the fundamental manufacturing paradigm. The corrugated converting line, the friction-fit electronics circuit module(s) retention, the flat-wrap fuselage construction, and the selective recovery architecture are invariant across all size classes.

The commercial advantage derives from production economics. Existing drone delivery platforms are manufactured as low-volume aerospace products at costs of thousands of dollars per unit, requiring return-on-investment timelines spanning thousands to millions of flight cycles. The disclosed system can be manufactured as a high-volume packaging product using existing converting infrastructure at rates of hundreds of units per hour. The expendable airframe cost is on the order of packaging, not aerospace. This volume-scale manufacturing approach enables economically rational one-way delivery without requiring the airframe to survive more than a single mission. Faster design iteration is a secondary benefit: because the airframe is expendable, design changes can be implemented immediately in production without concerns about fleet compatibility, retrofit programs, or depreciation of existing inventory.

### System Overview

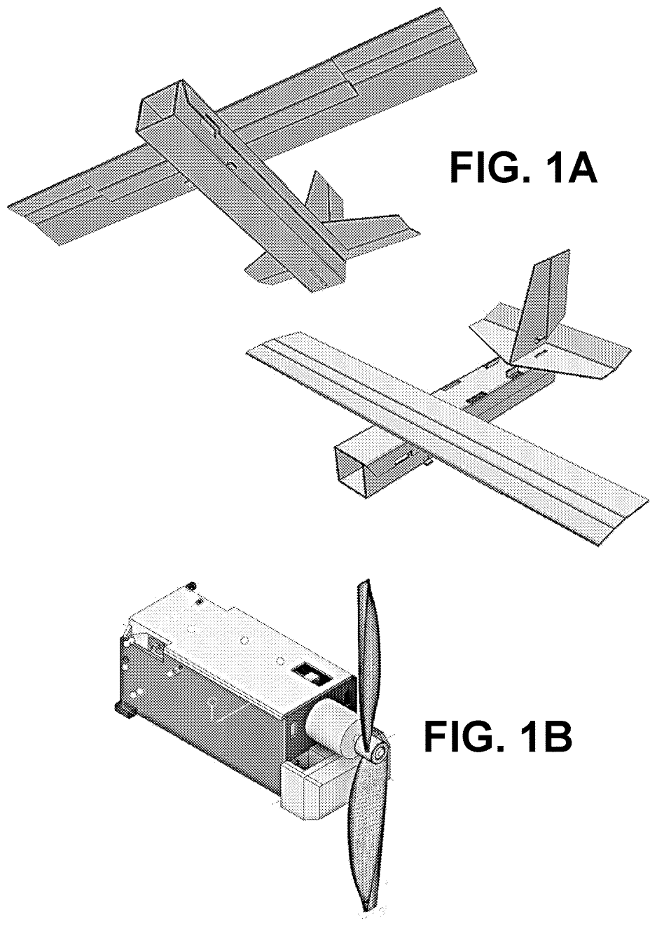

The disclosed system comprises a fixed-wing unmanned aerial vehicle employing a two-tier component architecture separating the expendable airframe from selective-recovery electronics circuit module(s). The airframe tier comprises corrugated paperboard components designed for single-use operation, material expendability, and integration with existing paperboard recycling infrastructure. The electronics tier comprises an autopilot system, power supply, propulsion motor, and sensing subsystems housed in one or more electronics circuit module(s), designed for recovery and reuse independent of the airframe. FIG. 1A illustrates an example of an airframe including a wing assembly, tail assembly and control surfaces and FIG. 1B illustrates an example of an electronics circuit module including a propeller, motor and power source, among other electronic components.

The packaging paradigm underlying the system contrasts with conventional aerospace and model aircraft construction. Rather than manufacturing airframes as discrete mechanical assemblies requiring tools, fasteners, and skilled assembly operations, the system treats the airframe as a converted product which can be manufactured on industrial packaging equipment. Corrugated paperboard is selected from flat sheet stock using rotary dies, the resulting blanks can be scored and folded into structural shape, and components can be bonded with adhesives compatible with packaging processes. This manufacturing approach permits production volumes aligned with commercial packaging converting rates, typically in the range of hundreds of units per hour from a single production line.

Every component of the airframe can be designed with production machine compatibility as a primary constraint. The selection of flat plate airfoil geometry, the wrap-around fuselage construction, the friction-fit electronics circuit module(s) retention, the fold-up vertical stabilizer, and the elimination of mechanical fasteners and linkages throughout the airframe are all direct consequences of optimizing for automated production on packaging converting equipment. The airframe can be hand-assembled in the field from flat-pack blanks without needing the production machine, but the design is holistically shaped by the manufacturing paradigm described below.

### Airframe Construction

Materials Selection. The primary structural material is corrugated paperboard, e.g., single-wall C-flute to E-flute construction. C-flute provides greater bending stiffness suitable for larger applications while E-flute provides reduced weight suitable for small format platforms. Flute direction (vertical or horizontal relative to structural axis) is important to performance and is specified in individual component definitions.

Optional coating materials for environmental protection include water-based wax emulsion, Michaelman barrier coatings, solid bleached sulfate (SBS) lamination, and lithographic (Lito) lamination. Coating selection prioritizes compatibility with paper pulp recycling infrastructure. Wax-coated corrugated paperboard remains compatible with paper recycling when processed through standard flotation deinking equipment. Coating is applied at the converting stage and adds no assembly operations.

Adhesives can include hot melt glue or pressure-sensitive tape formulations compatible with corrugated paperboard. These are standard materials in the paper industry and are compatible with paper pulp stream recycling without degradation of fiber quality.

Flute Orientation Strategy. Corrugated paperboard flute orientation is optimized for specific structural requirements. Fuselage sidewalls employ horizontal flute orientation (flutes parallel to fuselage axis), maximizing bending stiffness in the vertical plane and resisting nose-to-tail bending loads during flight acceleration and launch. Wing structure employs vertical flute orientation (flutes perpendicular to wing span), maximizing compression strength of the upper surface under aerodynamic load and preventing buckling of the compression strut in torsion.

Fuselage Construction. The fuselage is constructed through the following steps: A flat fuselage blank is die-cut from corrugated paperboard. The blank incorporates strategically located score lines defining fold regions. The blank is mechanically folded to create a tube cross-section approximately 1-5 inches in diameter, with overlap edges bonded using hot melt adhesive. Total fuselage length can be anywhere from 6-48 inches. The vertical stabilizer can be integrated into the fuselage blank to decrease component count and accelerate production.

Wing Assembly and Wing Brace. The wing is constructed from a single flat corrugated paperboard blank that is scaled to the wing loading requirements of the platform. A small unit can be on the order of 20 inch span and 3 inch chord up to 48 inch and 6 inch chord though these are not fixed numbers. The baseline wing profile employs a flat plate airfoil geometry, consistent with the low Reynolds number operating regime. Flutes run parallel to the span for best bending performance. The flat plate design exhibits superior glide performance at Reynolds numbers in the range of 40,000 to 120,000 compared to conventional cambered sections. This has the advantage of being extremely easy to make and assemble.

An enhanced wing profile variant can employ a Z leading edge crush treatment in which the top liner sheet of the corrugated paperboard is scored at, e.g., approximately 2 mm from the leading edge and pressed downward into the flute structure, producing a rounded leading edge geometry. The bottom liner sheet and flute medium can remain unchanged, preserving structural integrity. This crush operation needs only a score line and a pressing operation, both of which are standard converting operations compatible with rotary die-cutting equipment. The resulting profile reduces leading edge flow separation and extends the laminar run along the upper surface. Computational aerodynamic analysis demonstrates that this single converting-compatible operation meaningfully improves the lift-to-drag ratio relative to the unmodified flat plate while maintaining the fundamental manufacturing simplicity of corrugated paperboard construction. A trailing edge crush using the same technique further refines the aft pressure recovery. The full enhanced profile—designated “C optimal+crush”—needs only two score lines and a perimeter crease beyond the baseline flat plate die-cut, all operations achievable on standard converting equipment.

Wing bracing employs a corrugated paperboard wing brace bonded to the bottom of the fuselage. The wing brace starts as a flat plate of corrugated paperboard approximately the same or less chord than the upper wing. The brace is folded and bonded to the wing root region at approximately 50-70 percent of the wings. This geometry places the brace in tension where it resists buckling or twisting of the main upper wing. Additionally, the brace does provide some lift and the dihedral shape provides some self righting in roll.

Tail Assembly and Control Surfaces. The tail assembly employs control surfaces for pitch and yaw authority. The configuration can use a conventional elevator and rudder actuated by two servo motors. One servo actuator can be oriented flat and powers the full elevator surface via a custom wrap-around elevator geometry. The second servo actuator can be rotated 90 degrees and directly actuates the rudder. This two-servo architecture maintains minimum cost while providing independent pitch and yaw control. No ailerons are used; roll control is achieved through differential elevator input or yaw-roll coupling. Each control surface can be direct-mounted to a servo actuator with no mechanical linkage (pushrods, bellcranks, or control horns) between the servo and the surface. The vertical stabilizer can be fixed and integrated into the fuselage blank as described under Fuselage Construction.

The servo actuators can be mounted directly at the tail surfaces with electrical wires running aft from the receiver in the front module—a direct-drive, fly-by-wire arrangement that eliminates mechanical pushrods, control horns, and associated alignment issues. The servo mounting boxes can be integrated into the rear fuselage structure as part of the corrugated die line.

The rear fuselage box can be split into two pieces to enable modular snap-fit assembly. The horizontal stabilizer and elevator can drop in as one unit with self-locating alignment tabs that eliminate manual alignment—a common source of flight asymmetry in earlier builds. The vertical stabilizer and rudder servo can clamp on top. This modular approach enables rapid field assembly without jigs, fixtures, or measurement, and supports the broader manufacturing-ease narrative of the system.

Prior configurations evaluated during development included split independent elevators (elevons) for combined pitch and roll control, and taileron surfaces. The control surfaces can be made of polymers such as polyvinyl alcohol (PVOH) that do not affect paper recycling, or they can be corrugated fold-back surfaces returned as a tier-two item. Control surfaces can be directly integrated into the corrugated airframe die line, where the control surface geometry is cut and scored as part of the same blank that forms the fuselage and empennage, so that during assembly the control surfaces simply fold into their operating position. This eliminates separate control surface components entirely and only needs the servo interface to protrude from the otherwise all-paperboard structure.

### Electronics Circuit Module Design

Circuit Module Architecture. The electronics circuit module(s) are designed as discrete separable subsystem(s) independent of the airframe structure. The module(s) can comprise a flight controller, brushless direct current electric motor, battery, global positioning system (GPS) receiver, inertial measurement unit, barometric altitude sensor, and/or telemetry radio for ground station communication. Cooling channel geometry for thermal management during powered flight can be included. The module(s) can include provisions for external on/off switching and battery charging without opening the enclosure. The electronics circuit module(s) are produced independently and integrated into the airframe prior to flight.

The system can employ a front electronics circuit module containing the motor, battery, flight controller, and GPS, and a rear electronics circuit module containing the servo actuators with control surfaces direct-mounted thereto. The front and rear modules can be connected by an electrical harness that carries servo control signals and power-a fly-by-wire architecture analogous to that used in conventional manned aircraft-eliminating the need for mechanical pushrods or linkages between the forward and aft portions of the fuselage. Variants may employ wireless communication (e.g., Bluetooth) between the front and rear modules, further simplifying the wiring harness. The front and rear modules can be configured to combined in a single package for return shipping.

Enclosure Variants. The module enclosure can be provided in, e.g., two primary variants. An expendable enclosure is a lightweight shell designed to be expended with the airframe in fully disposable mission profiles such as those that may be encountered for, e.g., military applications. A returnable enclosure is a sealed shell with weatherproofing designed for recovery and reuse through multiple flight cycles as would be expected of, e.g., an ecommerce application. Enclosure selection is application-dependent and does not affect the friction-fit retention interface.

Module Retention Mechanism. The electronics circuit module(s) can be retained within the fuselage by one of several retention strategies. Examples are arranged in order of manufacturing simplicity: (1) friction-fit, in which the corrugated fuselage is wrapped around the enclosure(s) and glued to itself, with the wrap-around structure providing sufficient friction to keep the module(s) in place during flight; (2) tabs and slots or other mechanical interlocking features integrated into the die line; (3) other mechanical fasteners or links. Adhesive tape or glue remain options but are less preferred as they introduce consumables. The simplest retention that satisfies structural requirements during flight is preferred. Upon landing the corrugated is torn open at a perforation and the module(s) are withdrawn.

This architecture enables selective recovery. If airframe recovery is not practical the retention mechanism can be designed to be cheap and quick to assemble, with friction-fit being the simplest embodiment. The circuit module enclosure is designed to withstand landing impact forces and protect internal electronics circuitry.

Propulsion. The system employs an electric tractor configuration with a brushless motor mounted on the forward fuselage centerline. The propeller is attached directly to the motor shaft providing thrust aligned with the fuselage axis. Motor power can be scaled to the platform size and payload requirements. The tractor configuration was selected for simpler thrust-line alignment and center-of-gravity management.

### Wing Profile Selection

Experimental Approach. The initial design assumption was that a shaped wing cross-section would be needed for adequate aerodynamic performance. Given the constraint that the wing needed to be manufactured from corrugated paperboard on converting equipment, the design challenge was to identify wing profiles producible by folding corrugated sheet stock. Aspect ratio calculations were performed for KFm (Kline-Fogleman modified) airfoil variants, which offer the advantage of being formed by a single fold operation from corrugated stock. KFm profiles have been widely adopted in the hobby RC aircraft community for their simplicity. However, NASA wind tunnel testing has found that the Kline-Fogleman airfoil exhibited a lower lift-to-drag ratio than a flat plate, with pressure data indicating that lift generation mechanisms were identical to flat plate aerodynamics. Despite this finding, the hobby community has continued to adopt KFm profiles based on anecdotal flight performance, and rigorous low Reynolds number validation remains limited. Additionally, a series of novel folded wing cross-sections were designed based on packaging industry knowledge of corrugated folding behavior, designated G-1, G-1+, G-2, and T-1. The T-1 incorporated an integrated triangular spar formed from a single piece with fold lines. These designs were intended to produce a wing-shaped cross-section using only scoring and folding operations compatible with converting equipment.

Glide Test Methodology. Comparative glide testing was conducted using a custom-built crossbow-style launcher approximately 2 meters in length, selected as the most consistent and cost-effective launch method available. Vehicles were launched flat and nose-down at 14 degrees below horizontal. All test articles used identical fuselage bodies (10 gram control weight) with a 28-inch wingspan and B-flute corrugated construction, except where noted. Each configuration was tested across multiple trials to establish repeatability. Glide distance was measured from launch point to touchdown in feet.

Three control configurations were included: (1) a no-wing body to establish baseline ballistic trajectory, (2) a stock foam cambered wing from a commercial glider kit to establish conventional airfoil performance, and (3) a flat plate corrugated wing. The flat plate was introduced after early test data indicated that the additional weight of multi-layer corrugated folded profiles (KFm, G-series) might be negating their aerodynamic benefit. The flat plate was intended to test whether a lighter single-layer wing could compensate for its lack of camber through reduced mass. It was not expected to be aerodynamically competitive with shaped profiles.

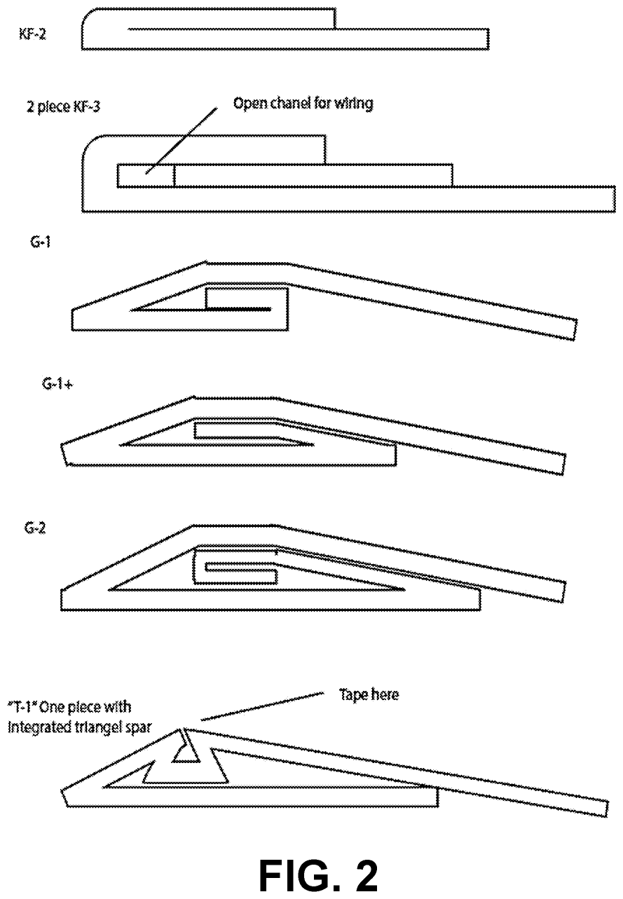

Test Configurations and Results. The wing profiles of Table 1 were tested, all on B-flute corrugated stock with 28-inch span unless otherwise noted. FIG. 2 illustrates cross-sectional views of examples of KF-2, KF-3, G-1, G-1+. G-2, and T-1 wing profiles. Table 1 presents glide distance results from a 3-meter crossbow launcher at two launch angles. The 0-degree (flat) launch angle is shown at left; the 14-degree nose-down launch angle is shown at right. The flat plate advantage over shaped corrugated profiles was consistent across both launch angles, confirming that the result is not an artifact of launch conditions.

TABLE 1

| | Weight | 0° Launch | −14° Launch | |
|---|---|---|---|---|
| Wing Profile | (g) | (ft) | (ft) | Notes |
| No wing (control) | 66.4 | — | 12.7 ± 0.8 | Ballistic baseline |
| Flat plate | 56.7 | 19.7 ± 0.5 | 16.8 ± 1.3 | Weight reference |
| KF2 | 95.2 | 15.9 | 10.3 ± 0.3 | Single fold |
| KF2 inverted | 95.2 | — | 10.5 ± 0.6 | Step on bottom |
| KF3 | 97.9 | 13.5 | 10.5 ± 0.5 | Four layers |
| KF3 inverted | 97.9 | — | 10.5 ± 0.4 | Step on bottom |
| G-1 | 93.2 | 14.8 | 16.0 ± 1.2 | Folded corrugated |
| G-2 | 101.3 | 14.8 | 16.5 ± 0.9 | Folded corrugated |
| Stock foam wing | 46.3 | 23.0 | 30.5 ± 1.9 | Foam, cambered |

Analysis and Convergence Finding. The flat plate configuration was included to test if weight was a performance factor. It unexpectedly outperformed all corrugated folded wing profiles (KF2, KF3, G-1, G-2 variants) at both launch angles. This result was initially treated with skepticism. The test team rejected the flat plate results for a period and attempted to identify experimental errors or confounding variables. The KFm and G-series profiles, despite their shaped cross-sections, performed at or below the no-wing ballistic baseline—likely due to the additional weight of multiple corrugated layers needed to form the shaped profile, combined with increased skin friction drag from the rough corrugated surface at low Reynolds numbers.

The stock foam cambered wing outperformed all corrugated configurations including the flat plate, achieving approximately 30.5 feet average distance versus 16.8 feet for the flat plate. This may be attributed to the foam wing's smooth surface finish (reduced skin friction drag) and molded leading edge profile. This result suggests that leading edge treatment and surface finish improvements to the corrugated flat plate can yield further performance gains.

Subsequent consultation with an aerospace engineer confirmed that flat plate airfoil competitiveness at the operating Reynolds number range (approximately 40,000 to 120,000) is consistent with published aerodynamic literature, though the result was described as surprising even to the specialist. At these low Reynolds numbers, the boundary layer behavior of shaped airfoils is significantly degraded, and the drag penalty of additional material thickness can outweigh the lift benefit of camber.

The convergence finding—that the simplest possible wing cross-section (flat plate, requiring zero additional manufacturing operations beyond die-cutting to planform shape) is also aerodynamically competitive at the operating Reynolds number—was not anticipated and is not suggested by conventional aircraft design practice. This unexpected convergence of the manufacturing constraint and the aerodynamic optimum converge at the same geometry, eliminates the traditional engineering trade-off between aerodynamic performance and manufacturing simplicity.

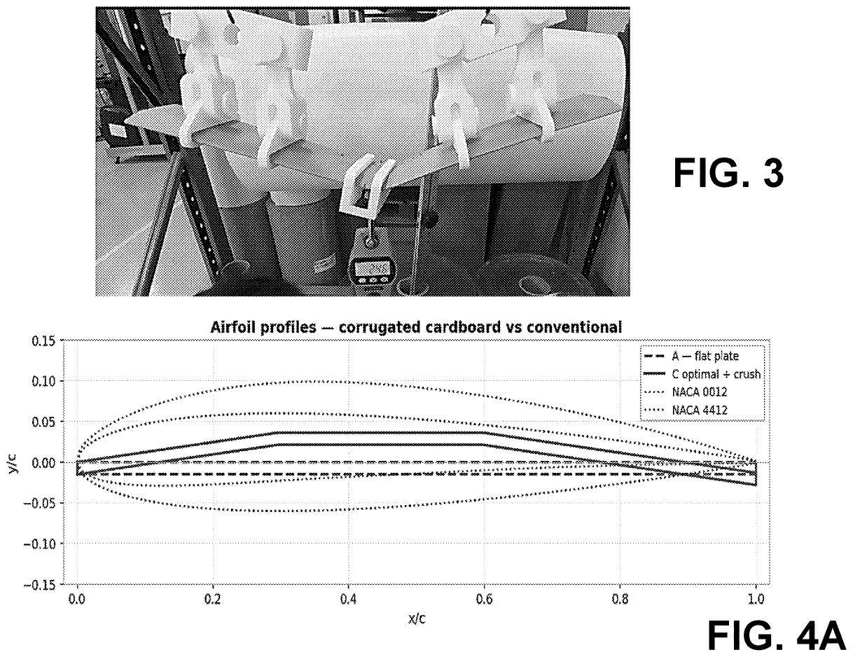

Wing Structural Testing. Structural load testing of the corrugated wing was conducted using a custom-built whippletree load distribution apparatus, as per aerospace industry standard practice for simulating distributed aerodynamic loads on wing structures. The whippletree distributes a single point load into multiple evenly spaced loading points across the wing span, approximating the distributed lift force experienced during flight. FIG. 3 is an image of the whippletree load distribution test on corrugated flat plate wing. 3D-printed clamps were used to apply the load to the corrugated wing at multiple span stations.

A digital scale measured the total applied load.

### Computational Aerodynamic Study

Wing Profile Progression. Following the convergence finding that flat plate geometry is aerodynamically competitive at the operating Reynolds number, a systematic computational study was conducted to evaluate whether converting-compatible modifications to the corrugated paperboard wing cross-section could further improve aerodynamic performance without compromising manufacturing simplicity. The study employed XFOIL (Drela, MIT) for conventional airfoil profiles and NeuralFoil for corrugated paperboard geometries with non-standard thickness distributions. All simulations were conducted at Reynolds numbers spanning the operating range of 40,000 to 120,000, with angle-of-attack (AoA) sweeps from −4° to 14° in 0.5° increments. Transition was modeled using N_{crit}=9, consistent with outdoor free-flight turbulence conditions.

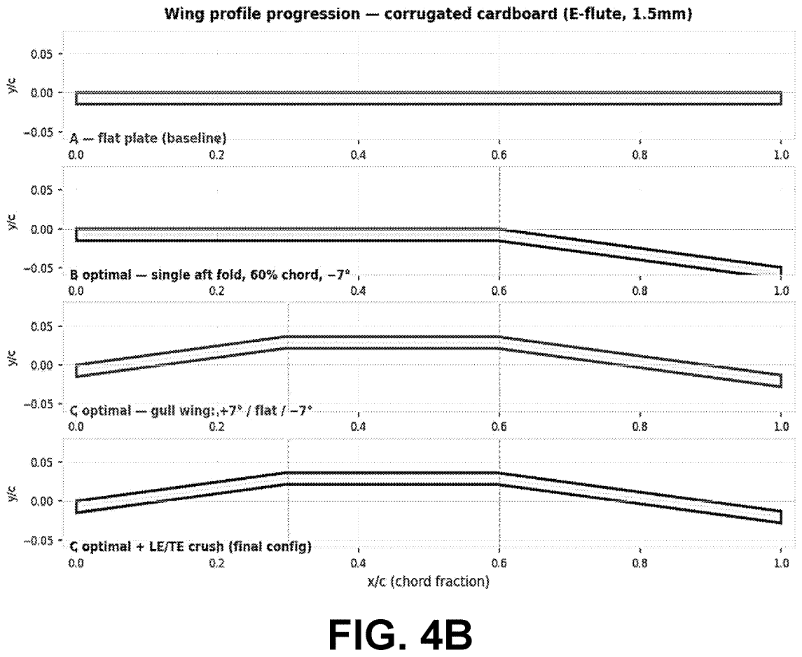

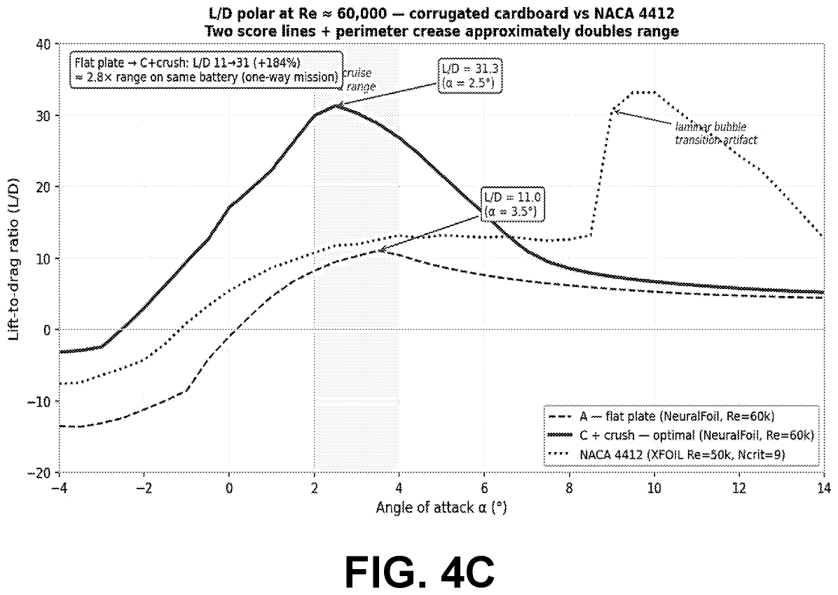

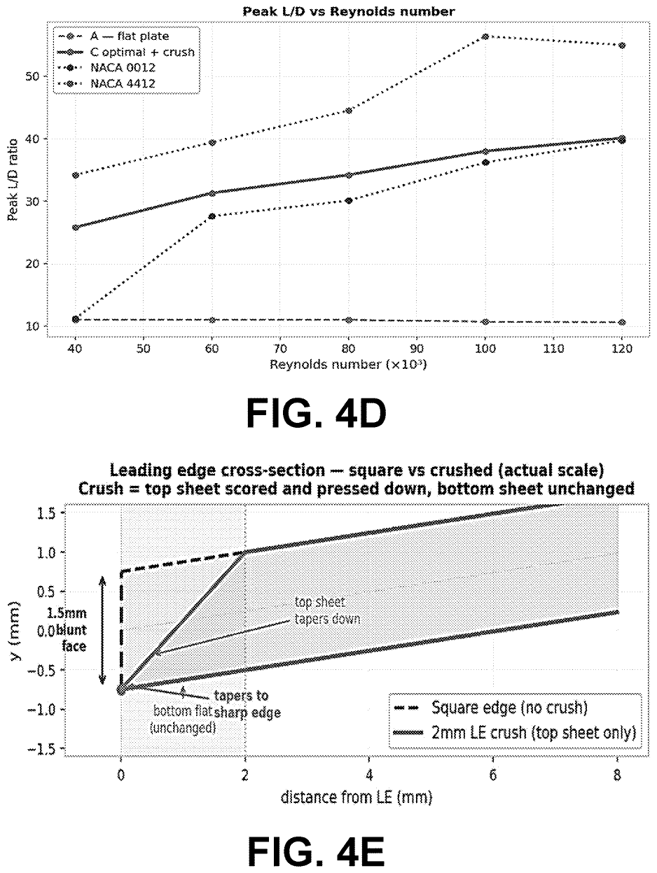

Four corrugated paperboard wing profiles were evaluated in a progressive sequence, each representing the addition of a single converting operation to the baseline flat plate. Profile A is the unmodified flat plate (baseline): a single layer of E-flute corrugated paperboard (approximately 1.5 mm thickness) cut to planform shape with no additional shaping. Profile B (single aft fold) adds one score line at approximately 60 percent chord on the upper surface, folding the aft portion downward by approximately 3 degrees to introduce mild trailing-edge reflex. Profile C (two-score-line configuration, designated “C optimal”) adds a second score line at approximately 30 percent chord to create a shallow cambered profile with the leading edge deflected upward approximately 7 degrees and the trailing edge deflected downward approximately 7 degrees. Profile C optimal+crush (final configuration) applies the leading edge and trailing edge crush treatment described in Section 1.6.2.4 to Profile C, producing a rounded leading edge and tapered trailing edge from the corrugated stock. FIG. 4A illustrates an example of the airfoil profiles overlay with corrugated paperboard variants versus conventional sections (NACA 0012, NACA 4412). The flat plate (A) and C optimal+crush profiles are producible entirely from corrugated paperboard using converting operations.

FIG. 4B illustrates the wing profile progression-corrugated paperboard (E-flute, 1.5 mm). Each step adds one converting operation: A (flat plate baseline), B (single aft fold, 60% chord, −7°), C optimal (Profile C, +7°/−7°), C optimal+LE/TE crush (final configuration). Quantitative performance results at Re=60,000 (all values with leading edge and trailing edge crush treatment) demonstrate a progressive improvement through the converting sequence. Profile A (flat plate baseline) achieves an L/D of 14.5 at peak efficiency. Profile B (single aft fold at 60% chord with −7° deflection) improves to an L/D of 23.8, representing a 64% gain over the flat plate baseline. Profile C (two-score-line configuration: 30% chord at +7° and 60% chord at −7°) further improves to an L/D of 31.3, a 116% gain compared to the flat plate baseline. Within Profile C itself, the leading edge and trailing edge crush treatment provides an 11% improvement in L/D compared to square-edge profiles. Notably, Profile C with crush achieves 83% of the peak L/D of the NACA 4412 conventional airfoil (31.3 versus 37.7 at Re=60,000), accomplished entirely through score-line folding and edge rounding of corrugated paperboard, with no molding or forming equipment needed.

FIG. 4C illustrates the L/D polar at Re=60,000-corrugated paperboard profiles versus NACA 4412. The C optimal+crush profile demonstrates a broadened high-L/D envelope relative to the flat plate baseline. Two score lines and a perimeter crease approximately double the estimated one-way range on the same battery. At the reference condition of Re=60,000 (representative of the small-format platform in cruise), the baseline flat plate (Profile A) achieved a peak lift-to-drag ratio (L/D) of approximately 11. The C optimal+crush configuration achieved a peak L/D of approximately 31.3 at a lower angle of attack (approximately 2.5° versus 3.5⁰), with a significantly wider usable L/D envelope and reduced sensitivity to angle-of-attack excursions. For comparison, the NACA 4412 conventional cambered airfoil at Re=50,000 (XFOIL, N_{crit}s=9) achieved a higher peak L/D but at a substantially higher angle of attack and with a sharper post-stall L/D collapse. The NACA 0012 symmetric section exhibited poor performance at these Reynolds numbers due to severe laminar separation.

FIG. 4D illustrates peak L/D versus Reynolds number for corrugated paperboard profiles (flat plate, C optimal+crush) and conventional airfoils (NACA 0012, NACA 4412). Corrugated profiles are competitive at the lowest Reynolds numbers where conventional sections suffer the greatest performance degradation. Peak L/D versus Reynolds number data across the full operating range confirms that the corrugated paperboard profiles track the performance trends of conventional airfoils but at lower absolute values, consistent with the thicker effective cross-section and surface roughness inherent to corrugated construction. Importantly, the C optimal+crush profile narrows the performance gap relative to conventional sections at lower Reynolds numbers, where laminar separation effects degrade conventional airfoil performance more severely than the corrugated profiles.

FIG. 4E illustrates an example of leading edge cross—section detail-square (unmodified) versus crushed (top sheet scored and pressed down, bottom sheet unchanged). (Actual scale, E-flute corrugated paperboard). The crush operation creates a tapered leading edge geometry using only a score line and pressing operation. The leading edge crush technique represents a novel application of corrugated paperboard converting operations to aerodynamic profile shaping. In the unmodified (square) leading edge, the top liner sheet, bottom liner sheet, and flute medium all terminate at the same chordwise station, creating a blunt rectangular edge that promotes immediate flow separation. In the crushed configuration, a score line is applied to the top liner sheet at, e.g., approximately 2 mm from the leading edge. The top liner is then pressed downward so that it conforms to the slope of the underlying flute medium. The bottom liner sheet remains unmodified and continues to the original leading edge station. The result is a tapered leading edge in which the upper surface begins approximately 2 mm aft of the lower surface, creating a geometry analogous to a thin wedge that reduces the severity of leading edge separation.

The significance of this result is twofold. First, it extends the convergence finding reported in the Analysis and Convergence Finding section above. Not only is the flat plate baseline competitive at the operating Reynolds number, but further aerodynamic improvements are achievable using operations that remain entirely within the converting equipment capability set. Score lines, crease lines, and pressing operations are standard corrugated paperboard converting operations performed on rotary die-cutters and folder-gluers at production speed. Second, the profile progression from A through C optimal+crush demonstrates a design methodology in which each incremental manufacturing operation provides a quantifiable aerodynamic benefit, enabling application-specific trade-offs between manufacturing cost and flight performance. A military expendable application may prefer the zero-operation flat plate, while a commercial delivery application may justify the additional two score lines and crease for improved range.

### Delivery Method and Mission Profiles

One-Way Flight Profile. The vehicle can be launched from the ground using hand-toss or catapult/rail launch. The production machine may have integrated launching. At launch an autopilot begins autonomous navigation toward a pre-programmed target location. The motor provides powered climb to an operational altitude and the vehicle follows a GPS-navigated flight path. Upon arrival at the target the autopilot can initiate automated descent. The drone can be operated autonomously to deliver payload to a pre-programmed location though specialty applications can leverage FPV or other guidance systems.

Fully Expendable Profile. In the fully expendable configuration, the entire vehicle including electronics circuitry is consumable in a single mission. The vehicle is launched, executes the delivery mission, and lands at the destination. No recovery infrastructure is needed. The airframe can be collected and recycled through standard paperboard recycling streams. This profile is most relevant to military and first responder applications where recovery logistics are impractical.

Selectively Returnable Profile. In the selectively returnable configuration, the electronics circuit module(s) can be recovered after each mission while the airframe is disposed of. Following landing, ground personnel or the consumer withdraws the electronics circuit module(s) from the fuselage and place the empty airframe in a recycling container. The electronics circuit module(s) are returned via mail or retail return point to a logistics hub where they are inspected, recharged, and integrated into a new airframe. The electronics circuit module(s) may include pre-paid return postage or a pre-addressed return shipping container. This approach decouples the optimization of the delivery leg from the return logistics: the delivery leg is optimized for flight speed, minimum airframe cost, and minimum battery capacity, while the electronics circuit module(s) are returned via lower-cost ground transportation at a longer time horizon. Consumers pay for the service of fast delivery, not fast return, and the one-way architecture reflects this asymmetry.

Landing Methods. Landing method selection is application-dependent. Military and first responder applications can employ controlled crash landing where the corrugated airframe is designed to absorb impact energy through crumple deformation. Civilian and ecommerce applications may employ a rear-deployed parachute for payload protection on landing. A swoop and tail-sit approach profile is a viable option for precision delivery. Additional landing methods can include, e.g., retro-thrust deceleration and deployable air brakes.

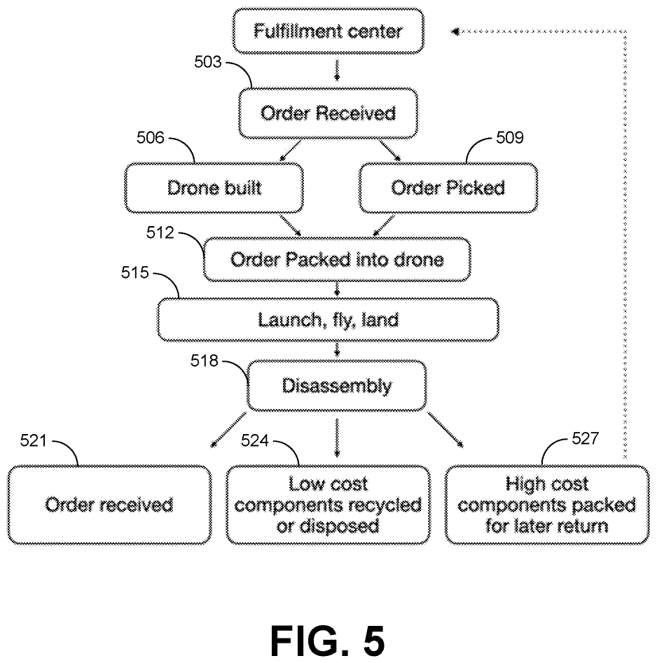

Delivery Method. The UAV/drone will fly one-way from the production location to the consumer delivery location. FIG. 5 is a flow diagram illustrating an example of a delivery method. Beginning at a fulfillment center, an order is received at 503. The UAV/drone is assembled at 506 and the order is obtained at 509. At 512, the order is packed in the UAV/drone and it is launched, flown and landed at the destination at 515. The arrival mechanism could be parachute, crash landing, soft lander, belly landing or other appropriate method. The UAV/drone can be disassembled at 518 and the order is considered delivered at 521. Low value components of the UAV/drone, such as the fuselage and wing assembly can be placed in curbside recycling at 524. High value components, like the motor and electronics circuit module(s) can be repacked into a return box (which can be included as an integrated piece) that can be mailed back at a later time at 527. The return box for the electronics may feature automated return postage included and preprinted on the exterior. The propeller may be collapsable to facilitate packing.

Production Machine. A distinguishing characteristic of the present invention is that the airframe is designed from the outset for compatibility with an integrated production machine. The production machine is not required to build or operate the vehicle—the airframe can be hand-assembled in the field from flat-pack blanks—but the holistic design of every airframe component is constrained by and optimized for automated production on packaging converting equipment. The selection of flat plate airfoil geometry, the friction-fit electronics circuit module(s) retention, the single-blank fuselage wrap, the fold-up vertical stabilizer, the elimination of mechanical fasteners and linkages, and the use of corrugated paperboard itself are all direct consequences of designing for this production paradigm. The production machine represents the full realization of the manufacturing method described throughout this specification.

The production machine can receive pre-assembled electronics circuit module(s) and flat corrugated paperboard blanks as inputs and produces flight-ready vehicles as output. The machine comprises the following stations operating in sequence:

A blank feeding system can provide flat corrugated paperboard blanks for the fuselage, wing, and wing brace from separate feed stations. A separate electronics circuit module feeding system can provide pre-assembled electronics circuit module(s) to the production line. A payload loading station receives and positions the payload within or adjacent to the electronics circuit module(s) prior to fuselage wrapping.

A fuselage wrapping station receives the flat fuselage blank and the electronics circuit module(s) with payload. The fuselage blank can be wrapped around the electronics circuit module(s) and bonded to itself using, e.g., hot melt adhesive, forming the fuselage structure with the electronics circuit module(s) retained by friction fit within the wrapped corrugated walls.

A center-of-gravity (CG) verification station can employ a dual-scale measurement system to confirm that the assembled fuselage with electronics circuit module(s) and payload has a center of gravity within acceptable flight limits. This station is particularly relevant when payload mass or position varies between units. Units failing CG verification are diverted for adjustment or rejection.

A wing placement station positions and bonds the wing to the upper surface of the fuselage and can bond a wing brace from the underside of the fuselage to the wing underside. At this stage, the airframe is structurally complete and a minimum viable production machine may terminate the production line here, producing assembled airframes for manual flight check and launch.

An extended production machine can further comprise an electronics flight check station that verifies communication with the flight controller, confirms sensor functionality (e.g., GPS lock, Inertial Measurement Unit (IMU) calibration, barometric altitude), tests servo actuation of control surfaces, and/or confirms battery charge state. Units failing flight check are diverted for diagnosis.

A launch system may be integrated into the production machine to deploy flight-ready vehicles directly from the production line. Launch methods can include electronic rail launch, capstan launch, pneumatic launch, or robotic arm launch. The electronic rail and capstan methods are preferred for consistent launch energy and repeatability at production rates. An integrated launch system permits continuous production-to-deployment operation without intermediate handling or storage.

### EXAMPLES

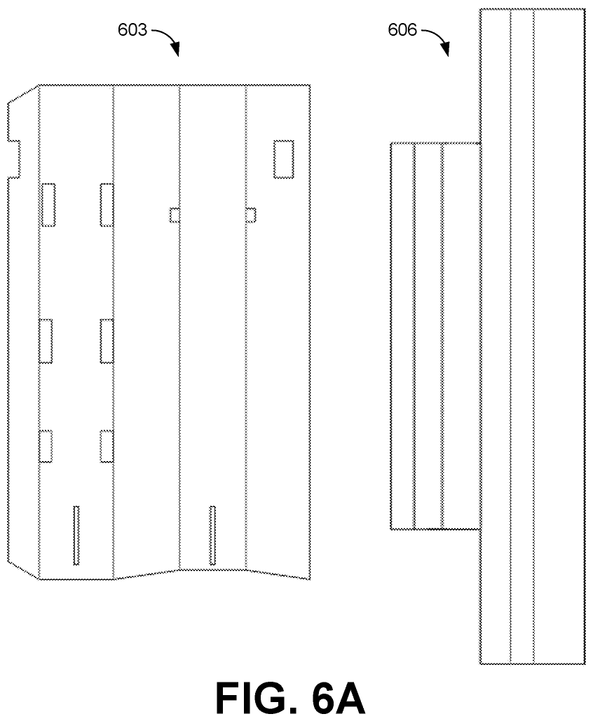

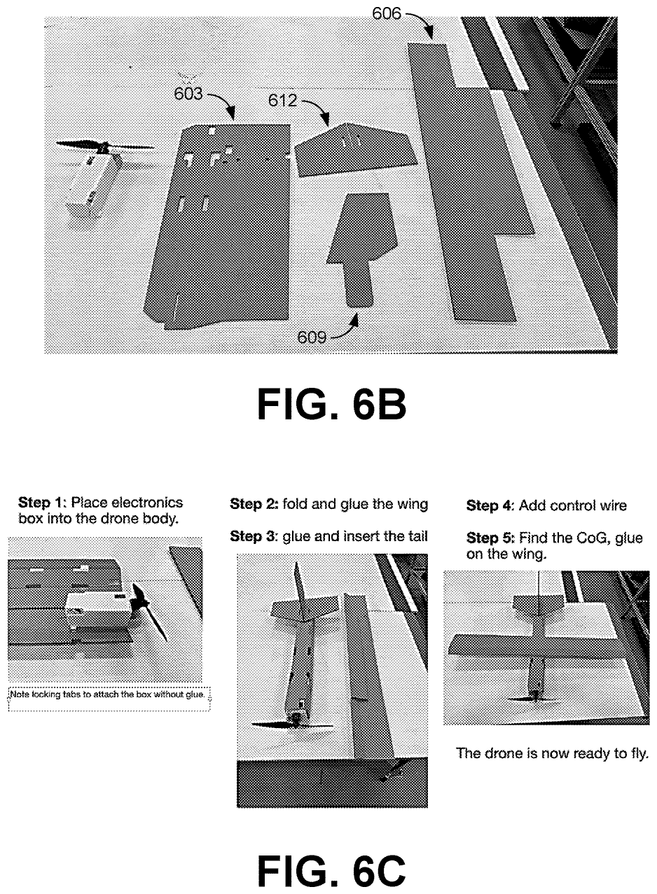

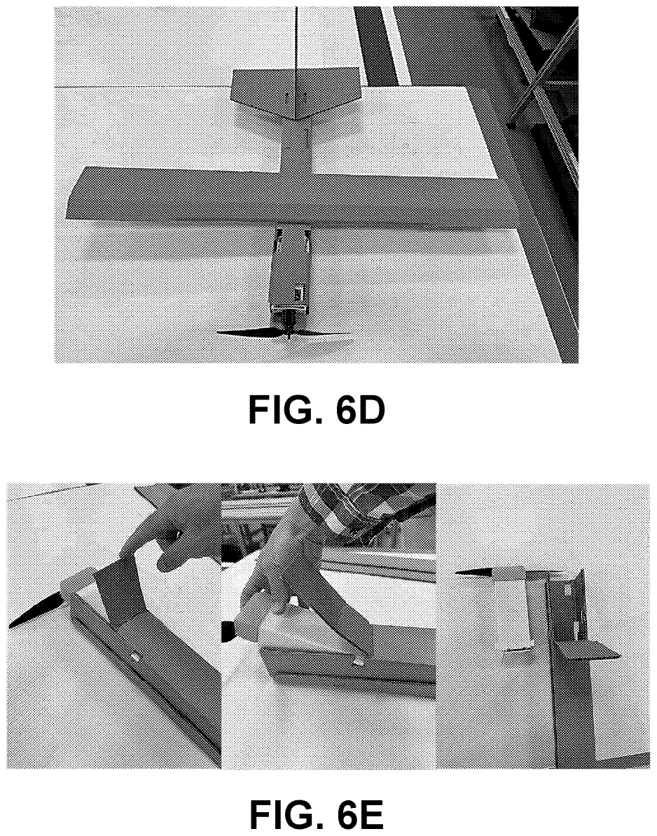

There are many possible UAV/drone configurations such as pull or pusher propellers, high or low wings, 3 or 4 channel, cruciform and v-tail; all with advantages and tradeoffs. FIG. 1A illustrates an example of an airframe including a wing assembly, tail assembly and control surfaces of a fabricated drone. It is possible to build a drone from any number of materials (e.g., plastic, corrugated plastic, wood, molded pulp, etc.). This fabricated drone utilized the novel combination of materials that enter the paper pulp stream. The papers can include wax coatings, Michaleman coatings, SBS, Lito lamination or other sizing, coatings, or layers that improve capabilities in inclement weather. The airframe and wing assembly can be produced from standard paperboard cutouts 603 and 606 as illustrated in FIG. 6A, which includes the fold lines.

FIG. 6B is an image of the paperboard cutouts 603 and 606 and paperboard cutouts 609 and 612 for the rudder and control surfaces of the tail assembly. The airframe 603 and airfoil for the wing assembly 606 are designed such that they can be rapidly produced with standard paperboard cutting dies and folded using traditional box making methods. It is possible to produce a Kline-Fogleman type 2 (KFm2) out of corrugated board using only a single fold. For the airfoil, the corrugations run parallel to the span. This provides good flexural stiffness and is the easiest fold. Testing shows the KFm2 needs a double crease to produce a 180 deg fold.

FIG. 1B illustrates an example of an electronics circuit module including a propeller, motor and power source, among other electronic components. This electronics circuit module is premade and can contain all the electronics needed to fly. This portion of the UAV/drone is the most expensive and is generally designed for reuse. The container can be plastic or other suitable enclosure material. These can be produced independently of the body and integrated prior to flight.

FIG. 6C illustrates an example of the assembly process of the UAV/drone.

Initially, the electronics circuit module(s) is/are placed on the paperboard cutout. As shown in FIG. 6C, tabs on the enclosure can be aligned with slots cutout in the paperboard to hold the electronics circuit module(s) in position. In other implementations, the electronics circuit module(s) are held in position by friction fit and/or are glued in position using an adhesive or glue. The paperboard is folded along the fold lines around the electronics circuit module(s) to form the airframe of the UAV/drone as shown. At step 2, the wing assembly is folded and glued to the airframe. The control surfaces 612 and rudder 609 of the tail assembly are then inserted and secured (e.g., glued) to the airframe at step 3. Control wires can be secured between the electronics circuit module and the tail assembly. The center of gravity (CoG) can then be located and the wing secured to the airframe. FIG. 6D is an image of the assembled UAV/drone ready for payload installation and delivery.

FIG. 6E illustrates the disassembly of the UAV/drone for the removal of the electronics circuit module after delivery of the payload is completed. The bottom of the airframe paperboard can be pulled away along perforations in the paperboard until the tabs of the enclosure are exposed. At that point, the electronics circuit module can be removed and the low cost airframe can be disposed or recycled.

Electronics Module Retention. Multiple retention mechanisms were evaluated for securing the electronics module within the airframe fuselage. Subsequent testing evaluated additional approaches including: pusher mechanisms, various mechanical locking mechanisms, adhesive bonding (glue), and dowel pin retention. Locking tabs can be eliminated to avoid impact on flat-pack packing density during shipping and storage. Friction fit offers an advantage because it requires no additional hardware, permits rapid insertion and extraction, provides adequate retention force under flight acceleration loads, and is fully compatible with the packaging converting production paradigm.

Wing Profile Selection. An extensive series of wing cross-section profiles were evaluated during development. Early prototypes employed a Kline-Fogleman type 2 (KFm2) stepped airfoil, formed by a single fold of corrugated board with corrugations running parallel to the span for flexural stiffness. The KFm2 utilized a double crease to achieve the 180-degree fold, and testing quantified an approximately 20 percent glide performance reduction compared to traditional cambered airfoils. Subsequent iterations included the G-1, G-1+, G-2, T1, and Z-plane KF-3 configurations (see FIG. 2), each representing variations on folded and stepped geometries with different tradeoffs between manufacturing simplicity and aerodynamic performance.

Ultimately, flat plate geometry was utilized based on the convergence of aerodynamic viability at the operating Reynolds number range (approximately 40,000 to 80,000 for the small-format variant) and zero additional manufacturing operations needed beyond die-cutting to planform shape. Published literature and experimental glide testing confirm that flat plate airfoils provide aerodynamically competitive lift-to-drag performance relative to cambered and stepped profiles at these Reynolds numbers. The KFm2 and other stepped profiles, while producible from corrugated stock, require folding and creasing operations that add assembly time and introduce quality-control variability. The flat plate is the only profile that is both aerodynamically competitive and producible with no shaping operations.

Wing Brace Configuration. Multiple wing support and bracing configurations were evaluated. Support and bracing approaches include, e.g., doubled brace (two parallel brace elements per wing panel), and an inverted configuration in which the lower dihedral surface served as the dominant lifting wing with the upper surface functioning as a structural brace. A single inverted-V brace configuration was selected because it carries primarily tensile loads under aerodynamic lift (material-appropriate for corrugated paperboard), imparts dihedral angle for passive roll stability, and is producible from a single die-cut blank with two score lines.

Empennage Configuration. Multiple tail configurations were evaluated during development. Configurations tested include, e.g., rectangular conventional tail, V-tail, and asymmetric L-tail. The rectangular configuration provided adequate pitch and yaw control authority but needed separate horizontal and vertical stabilizer components with associated assembly operations. The V-tail configuration reduced component count but introduced control mixing complexity and coupling between pitch and yaw channels. The asymmetric L-tail was evaluated as a compromise but exhibited asymmetric aerodynamic characteristics. A fixed vertical stabilizer integrated as a fold-up extension of the fuselage blank can be employed, combined with split independent elevator surfaces (elevons) for combined pitch and roll control.

Vertical Stabilizer. Flight testing confirmed that a fixed vertical stabilizer is needed for directional stability. Variants without a vertical stabilizer exhibited uncontrollable yaw divergence. This finding informed the final tail design: the vertical stabilizer is integrated into the fuselage blank as a fold-up tab, adding no additional components or assembly operations.

Control Surface Actuation. Mechanical linkage systems (e.g., pushrods, bellcranks, control horns with clevis connections) were initially evaluated for control surface actuation, consistent with conventional model aircraft practice. The intial prototype (Mallard class) routed metal control rods through the corrugated fuselage structure to fenced control horns at the tail. This approach encountered rod bending under flight loads, difficulty achieving consistent alignment through the corrugated structure, and challenges in making metal rods compatible with the paper recycling stream.

These mechanical linkages were eliminated by adopting a split electronics circuit module architecture in which a rear electronics circuit module containing servo actuators is positioned at the tail of the airframe. The front and rear modules can be connected by an electrical harness-effectively a fly-by-wire architecture as used in traditional manned aircraft—or with a wireless communication link, which entirely replaces the mechanical linkage. Each servo actuator direct-mounts to its control surface with no intermediate mechanical components. This eliminates pushrods, bellcranks, and control horns, reducing part count, eliminating recyclability concerns from metal components, and removing the rod-bending failure mode.

Control Surface Configuration. Multiple control surface configurations were evaluated during development. Initially, corrugated elevons with servos directly integrated into the control surfaces were employed using only a crease line as the hinge. This proved that corrugated could function as a control surface but was not conducive to recyclability or returnability, as the servos were embedded in the expendable structure.

Split independent elevators (elevons) at the tail were evaluated on subsequent prototypes. These provided combined pitch and roll control authority from servo actuators housed in the recoverable electronics circuit module(s), keeping all active control components in the recoverable tier. Tailerons (split horizontal stabilizer providing both pitch and roll control) were subsequently designed, built, and flight-tested at Finch (Martin class) scale. Finding: insufficient roll authority at this wingspan and Reynolds number. The aircraft also required a vertical stabilizer for yaw stability, which eliminated the part-count advantage of tailerons—needing three servos (two tailerons plus rudder) instead of two (elevator plus rudder) for the conventional empennage. This study result led to convergence on the conventional empennage: fixed horizontal stabilizer with elevator, fixed vertical stabilizer with rudder, two servos.

A current configuration employs a conventional elevator and rudder actuated by two servos, both housed in the rear electronics module. One servo powers the full elevator via a custom wrap-around geometry; the second servo is rotated 90 degrees and directly actuates the rudder. This achieves two-surface control authority with minimum servo count while keeping all actuators in the recoverable tier. The control surfaces are directly integrated into the corrugated airframe die line—cut and scored as part of the same blank—so they fold into their operating position during assembly, eliminating separate control surface components.

Servo and Electronics Routing. A single-box electronics circuit module housing all components (motor, battery, flight controller, GPS, and servo actuators) was extensively evaluated. Multiple enclosure geometries were developed (compact cube, hexagonal cross-section for pusher configurations, side-access flip-lid, wide-format variants) to accommodate all electronics in a single recoverable unit. This consolidated approach was ultimately updated because servo actuators were needed in proximity to the tail control surfaces while the motor and battery are located at the forward fuselage, and the resulting single-box geometry produced unfavorable center-of-gravity characteristics and assembly complexity.

The current design employs a split architecture: a front electronics circuit module (motor, battery, flight controller, GPS) and a rear electronics circuit module (servo actuators with direct-mounted control surfaces). The front and rear modules can be connected by an electrical harness carrying servo control signals and power. This electronic connection between modules eliminates the need for mechanical pushrods, bellcranks, or control horns running through the fuselage structure. Wireless communication (e.g., Bluetooth) can be employed for communication between the electronics circuit modules to eliminate the wiring harness entirely. Both modules are recoverable and can be joined together for return shipping.

Wing Chord and Aspect Ratio. Multiple wing chord and span combinations have been evaluated through glide testing to characterize the relationship between planform geometry, Reynolds number, and glide performance. Reducing chord length reduces the operating Reynolds number, which may improve flat plate aerodynamic performance in the target regime. However, high-aspect-ratio planforms (long span, narrow chord) introduce structural challenges in corrugated paperboard and may not be optimal. Results indicate that the current 4-inch chord, 22-inch span (aspect ratio 5.5) configuration provides a reasonable balance of aerodynamic performance and structural integrity.

Propulsion Configuration: Tractor versus Pusher. Both tractor (front-mounted, puller) and pusher (rear-mounted) propulsion configurations were extensively evaluated. Multiple pusher configurations were developed, including hexagonal cross-section pusher modules optimized for delivery system integration (e.g., Amazon-style conveyor compatibility). The pusher configuration offered advantages for certain landing methods, reduced propeller exposure during ground handling, and favorable geometry for through-system logistics. However, integration of pusher configurations presented difficulties in view of achieving acceptable center-of-gravity balance while accommodating payload, battery, flight controller, and motor in a rear-mounted configuration required complex enclosure geometries that were difficult to manufacture and assemble.

The tractor configuration was selected for the current design due to simpler thrust-line alignment, more straightforward center-of-gravity management, and compatibility with the current fuselage wrap construction. The initial (Mallard class) prototype achieved 25 mph powered flight in tractor configuration on a 4S LiPo battery. The tractor configuration also simplifies emergency landing options by keeping the propeller clear of rear-mounted recovery systems.

Landing and Recovery Methods. Multiple landing and recovery methods have been evaluated for different application contexts. Methods include, e.g., parachute deployment from the tail section, retro-thrust using CO2 cartridges for terminal deceleration, deployable air brakes for drag augmentation during approach, controlled swoop-and-stall maneuvers, and tail-sitter vertical landing profiles. The current design employs either a controlled crash landing (military and first-responder applications, where the airframe is fully expendable and landing zone preparation is not assumed) or a rear-deployed parachute for ecommerce and civilian delivery applications where payload protection on landing is needed. The swoop and tail-sit method remains a viable option for precision delivery. Landing method selection is application-dependent: military and first-responder use cases do not require sophisticated recovery systems, while civilian ecommerce applications may warrant parachute or precision landing capability.

Wing Placement and Configuration. Multiple wing placement locations and configurations were evaluated including high-wing, low-wing, and mid-wing mounting positions relative to the fuselage centerline. Six distinct wing placement locations were assessed during early design studies. High-wing configuration was selected for the current design based on favorable lateral stability characteristics, simplified wing-to-fuselage attachment geometry (the wing sits on top of the fuselage wrap), and compatibility with the inverted-V brace operating in tension under lift loads.

Battery Configuration. Battery configuration evolved substantially during development. Early prototypes employed lithium polymer (LiPo) packs, with the initial prototype achieving 25 mph powered flight on a 4S LiPo. LiPo packs provide high discharge rates but are not field-swappable without module access and require external charging infrastructure.

Lithium-ion 21700-format cylindrical cells offer an endurance-oriented alternative. The 2170 Super Base module design demonstrated a hot-swappable battery concept using snap-on battery contacts connected on the back side with nickel strips. This configuration permits field replacement of individual cells without module disassembly, enabling rapid turnaround between flights. An open-top module variant specifically accommodates top-loading of cylindrical cells during pre-flight assembly. The closed-top variant retains external charge leads for in-situ charging. Both LiPo and Li-ion configurations can be supported by the module architecture; battery chemistry selection is application-dependent based on energy density, discharge rate, and field-serviceability requirements.

Further Designs. A current design iteration, designated Finch (Martin class), incorporates lessons learned from flight testing and represents a refinement of the corrugated paperboard drone airframe. Initial flight testing confirmed that the center of gravity placement and overall weight balance were correct. The tail assembly incorporates a conventional tail layout with enlarged control surfaces featuring a dedicated vertical stabilizer with hinged rudder and a horizontal stabilizer with hinged elevator, providing substantially increased control surface area and moment arm. This design change addresses a control authority deficit while maintaining the corrugated paperboard construction methodology central to the design. The conventional tail components are manufactured from flat corrugated paperboard sheet stock using the same converting operations (scoring, creasing, folding) described throughout this disclosure.

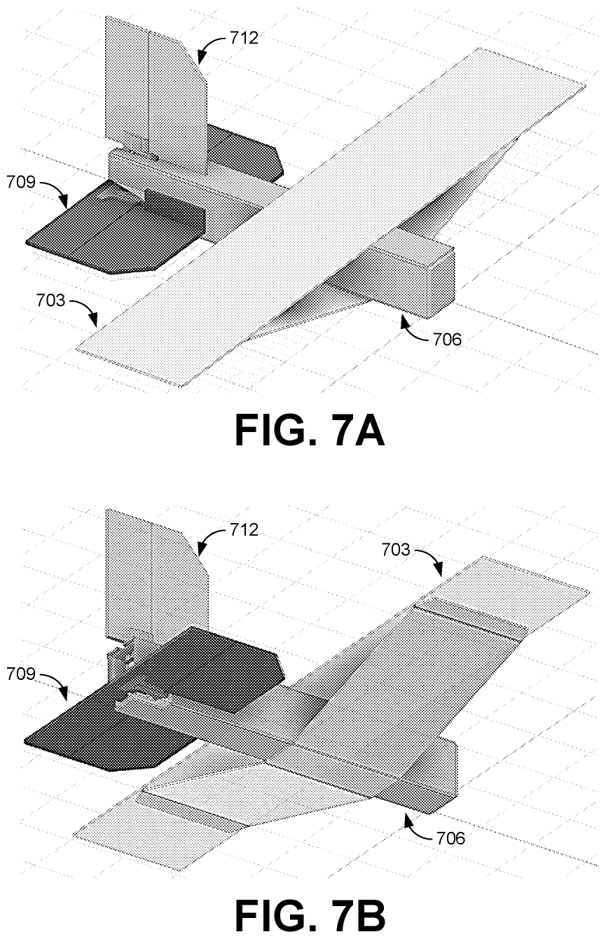

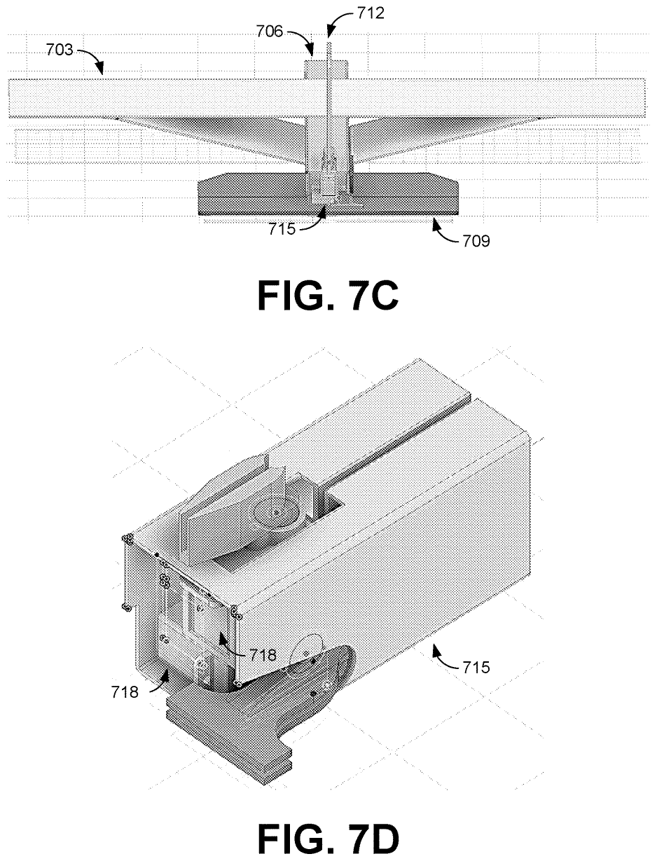

FIG. 7A shows an isometric view of the design from a front starboard perspective. The corrugated paperboard wing 703, fuselage or airframe 706, horizontal stabilizer of the control surfaces 709, and vertical stabilizer with rudder 712. The enlarged control surfaces 709 provide increased pitch and yaw authority. FIG. 7B shows an isometric view of the design from a rear port perspective. The horizontal stabilizer undersurface and vertical stabilizer/rudder assembly are visible. Wing brace strut connects wing 703 to the fuselage 706. A split electronics circuit module architecture with a direct servo mounting is visible in the fuselage cutaway. FIG. 7C shows an isometric view of the design from a center rear perspective. The vertical stabilizer is centered on fuselage 706 spine, with the horizontal stabilizer providing pitch authority. The wing span and dihedral angle are visible. A motor and propeller are mounted in tractor configuration forward of wing 706 leading edge in the electronics circuit module.

FIG. 7D illustrates an example of an electronics circuit module 715 comprising a micro servo installation. Direct-mount micro servo actuators 718 can be used to drive the elevator control surfaces and rudder. The micro servo installation employs direct servo mounting within the fuselage structure, with the servo horn driving the control surface through a short mechanical linkage. This direct-drive approach eliminates the long pushrod runs used in earlier prototypes, reducing mechanical complexity and improving control response. The servo mounting pocket is integrated into the corrugated paperboard fuselage structure, demonstrating that the airframe material itself can serve as structural mounting for electromechanical components. The electronics circuit module can comprise a printed circuit board (PCB) in the bay forward of the servo.

Bluetooth-controlled servo actuators with integrated local batteries can also be used. In this configuration, each servo module contains a Bluetooth Low Energy (BLE) receiver, a micro servo, and a dedicated lithium cell, operating as a fully self-contained wireless actuator. The flight controller in the front electronics circuit module transmits control signals wirelessly to the rear servo electronics circuit module(s), eliminating not only the mechanical pushrods of earlier prototypes but also the electrical wiring harness between the front and rear electronics circuit module(s). This wireless actuator architecture maximizes the independence between the recoverable electronics (front module) and the expendable airframe, as the rear servo modules can be treated as low-cost expendable components—their combined cost (micro servo, BLE receiver, lithium cell) being sufficiently low to discard with the airframe after a one-way mission. This approach represents the logical endpoint of the split electronics module architecture: the front electronics circuit module is a high-value recoverable unit containing the flight controller, GPS, and primary battery, while the rear actuator modules can be disposable wireless servo units embedded in the expendable corrugated paperboard tail structure.

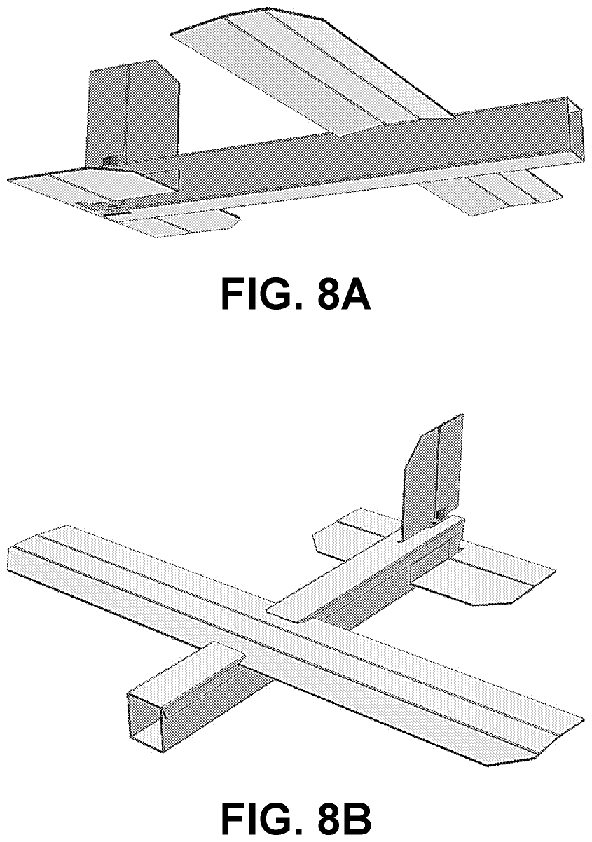

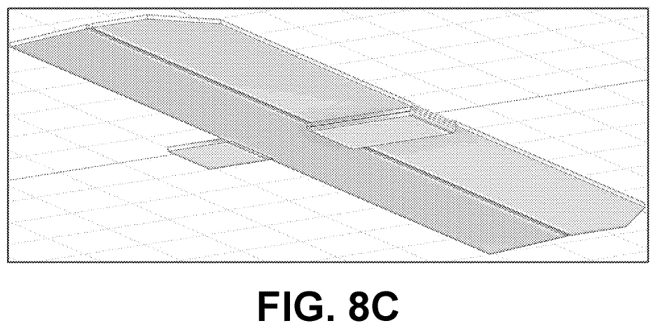

Another Finch iteration integrates Profile C wings using a slot mechanism that allows the folded wing to pass through the fuselage without a separate strut brace. FIGS. 8A and 8B illustrate an example of the design arrangement. FIG. 8A shows a side isometric view with two score lines defining the Profile C (30% chord at +7° and 60% chord at −7°) visible as score marks on the wing panels. This slotting approach simplifies assembly and can eliminate the need for the wing brace strut, reducing parasitic drag and further improving the expendable airframe's cost-performance ratio. FIG. 8B shows a forward starboard isometric view. The slot mechanism is visible where the wing passes through fuselage section. Score lines on both wing and tail surfaces indicate fold positions for Profile C geometry. In other arrangements, a fold-up spacer wing mount as shown in FIG. 8C can be utilized replacing the slot-through-fuselage mounting. The score-and-fold can be integrated into the fuselage blank and the tab can be glued to maintain the wing camber. The vertical CG offset ca improve the lateral stability. This design can simplify production compared to the through slot design. The positioning of the wing can also be adjusted for payload CG.

In one aspect, among others, a fixed-wing UAV or drone for payload delivery, can comprise an airframe formed from flat sheet stock material using converting operations including at least cutting and folding along pre-formed fold lines, the airframe being erectable from a substantially flat configuration to a flight-ready three-dimensional configuration; and at least one electronics circuit module removably housed within the airframe. The at least one electronics circuit module can comprise at least a motor, a battery, and/or a flight controller; wherein the airframe is configured for one-way flight from a launch point to a delivery point. In one or more aspects, the converting operations can be packaging industry converting operations including at least one of rotary die-cutting, flatbed die-cutting, scoring, and/or folding performed by packaging converting equipment. The at least one electronics circuit module can be retained within the airframe by friction fit without mechanical fasteners, the airframe walls can provide sufficient clamping force to secure the at least one electronics circuit module during flight. A fuselage portion of the airframe can be formed by wrapping a flat blank around the at least one electronics circuit module and adhesively bonding the flat blank to itself, the friction fit resulting from the wrapped blank geometry.

In various aspects, the flat sheet stock material can be corrugated paperboard with flutes oriented parallel to a wingspan for wing components. The corrugated paperboard can have a flute size selected from E-flute, B-flute, or C-flute based on a target wingspan and/or a payload capacity. The flat sheet stock material can be selected from corrugated paperboard, solid paperboard, corrugated plastic, or foam board. The corrugated paperboard can be recyclable in a paper pulp stream. In some aspects, the airframe can include a fuselage formed from a single blank that wraps around the at least one electronics circuit module, a cross-sectional shape of the fuselage being defined by exterior dimensions of the at least one electronics circuit module. The fuselage blank can further include an integrated vertical stabilizer formed as a fold-up extension of the fuselage blank. The airframe can further comprise a fixed vertical stabilizer, the fixed vertical stabilizer providing directional stability.

In one or more aspects, the fixed-wing UAV or drone can comprise a wing having a cross-section formed from corrugated paperboard using converting operations, the wing cross-section operating at a chord Reynolds number in the range of approximately 40,000 to 120,000. The wing cross-section can be a flat plate comprising no additional shaping operations beyond cutting to planform, the flat plate providing aerodynamically competitive lift-to-drag performance relative to cambered and stepped airfoil profiles at the operating Reynolds number. The fixed-wing UAV or drone can comprise a wing brace formed from a single piece of sheet material. The wing brace can be creased at two locations and folded to form an inverted-V configuration extending from an underside of the fuselage upward to an underside of the wing, the wing brace configured to carry primarily tensile loads under aerodynamic lift. The wing brace can impart a dihedral angle to the wing for passive roll stability. The wing brace can be formed from corrugated paperboard. The wing cross-section can include at least one score line defining a fold that introduces camber or reflex into the corrugated paperboard, the fold being a converting operation compatible with rotary die-cutting equipment. The wing can include a leading edge crush treatment in which a liner sheet of the corrugated paperboard is scored proximate to the leading edge and pressed into the flute structure, producing a tapered leading edge geometry that reduces flow separation. The crush treatment can be achieved by a score line and pressing operation on converting equipment. The wing cross-section can be selectable from a family of profiles of increasing aerodynamic performance. Each successive profile can require one additional converting operation, enabling application-specific trade-offs between manufacturing simplicity and flight range.

In various aspects, the vehicle can have no ailerons, and roll control can be provided by split independent elevator surfaces (elevons) at the tail. Control can be provided by a first servo actuator powering an elevator surface and a second servo actuator powering a rudder surface. The control surfaces can be configured to fold into the footprint of a rear electronics circuit module for return shipping. The control surfaces can be detachable from the rear electronics circuit module for return shipping. Each control surface can be direct-mounted to a servo actuator with no mechanical linkage between the servo and the control surface. The servo actuators and control surfaces can be housed in or mounted to a rear electronics circuit module.

In some aspects, the at least one electronics circuit module can have an open top, the open top being enclosed by the airframe fuselage when the airframe is erected around the at least one electronics circuit module, permitting top-loading of battery cells into the at least one electronics circuit module during pre-flight assembly. The at least one electronics circuit module can comprise a fully closed enclosure with an external charge cable port, such that battery management and recharging can be performed without opening the enclosure, enabling rapid turnaround in high-volume commercial operations. The fixed-wing UAV or drone can comprise a front electronics circuit module containing at least a motor, battery, flight controller, and GPS; and a rear electronics circuit module containing at least servos with control surfaces direct-mounted thereto. The front and rear electronics circuit modules can be connected by an electrical harness carrying servo control signals and power (the electrical harness can replace mechanical pushrods or linkages). The front and rear electronics circuit modules can communicate wirelessly (eliminating a physical wiring harness between the modules). The rear electronics circuit module can comprise one or more servo actuators, each servo actuator having an integrated wireless receiver and a dedicated local battery. The servo actuators can receive control signals wirelessly from the front electronics circuit module via a short-range wireless protocol (thereby eliminating all physical electrical connections between the front and rear electronics modules and enabling the rear electronics module to operate as a self-contained wireless actuator unit). The short-range wireless protocol can be Bluetooth Low Energy (BLE). The dedicated local battery can be a lithium cell sized for single-mission endurance. The local battery and wireless receiver can be co-packaged with the servo actuator as a unitary wireless servo module mountable directly in the corrugated paperboard airframe structure. The front and rear electronics circuit modules can be configured to join together into a single package for return shipping. The at least one electronics circuit module can comprise hot-swappable cylindrical battery cells retained by snap-on battery contacts with conductive strip connections, permitting field replacement of individual cells without module disassembly. The at least one electronics circuit module can comprise pre-paid return postage or a pre-addressed return shipping container.

In one or more aspects, the fuselage can be formed by wrapping a flat corrugated blank around the at least one electronics circuit module on a converting line, the fuselage cross-sectional geometry being defined by the exterior dimensions of the at least one electronics circuit module and the wrapping process of the fuselage wrapping station. The airframe can include a perforation in the fuselage wall positioned to permit tearaway access to the at least one electronics circuit module upon landing without requiring tools. The center of gravity of the assembled UAV or drone can be verified by a dual-scale measurement during production, the payload position being adjusted to maintain the center of gravity within flight-acceptable limits.

In another aspect, a method of manufacturing an UAV or drone airframe can comprise providing a flat blank of sheet material having pre-formed fold lines and cut features; erecting the flat blank into a three-dimensional airframe structure by folding along the pre-formed fold lines; inserting at least one pre-assembled electronics circuit module into the erected airframe such that the at least one electronics circuit module is removably retained within the airframe structure. In one or more aspects, the manufacturing method can be compatible with packaging industry converting equipment. In one or more aspects, the packaging industry converting equipment can comprise at least one of rotary die-cutters, flatbed die-cutters, folder-gluers, case erectors, and/or wrap-around cartoners. Production volume can be scalable to hundreds of airframes per hour from a single converting line. The airframe can be designed for field assembly with no requirement for specialized tools.

In another aspect, a method of delivering a payload can comprise erecting a fixed-wing UAV or drone airframe from a flat sheet stock blank by folding along pre-formed fold lines; inserting at least one pre-assembled electronics circuit module into the erected airframe; loading a payload into the drone; flying the drone one-way from a launch point to a delivery point; and at the delivery point, at least one of: (a) disposing of the entire drone including the at least one electronics circuit module, (b) separating the at least one electronics circuit module from the airframe and returning the at least one electronics circuit module to the originator, or (c) recovering the complete vehicle. the drone arrives at the delivery point via controlled crash landing, the corrugated airframe absorbing impact energy through crumple deformation. In one or more aspects, the UAV or drone can arrive at the delivery point via controlled crash landing, the corrugated airframe absorbing impact energy through crumple deformation. The UAV or drone can arrive at the delivery point via parachute deployment. The UAV or drone can arrive at the delivery point via a tail-sitter approach profile. The battery capacity, wing area, and structural mass of the UAV or drone can be sized for the one-way delivery leg, the vehicle carrying no reserve energy or structural capacity for a return flight.

In various aspects, returning the at least one electronics circuit module to the originator can comprise the recipient depositing the at least one electronics circuit module at a retail return point, the at least one electronics circuit module being returned to the originator via ground shipping. The airframe can be disposed of at the delivery point by the recipient placing the corrugated paperboard airframe into a paper recycling stream. A one-way flight profile decouples speed and cost optimization of the delivery leg from the return logistics of the at least one electronics circuit module, the delivery leg being optimized for flight speed and minimum airframe cost while the at least one electronics circuit module returns via lower-cost ground transportation at a longer time horizon. The at least one electronics circuit module can be returned to the originator in a consolidated batch from a retail return point, reducing per-unit return logistics cost. The at least one electronics circuit module can be recovered at the delivery point, recharged or provided with a fresh battery, inserted into a new airframe, and flown back to the originator or to a subsequent delivery point. The at least one electronics circuit module can be recovered at the delivery point and returned to the originator via a local collection point where the at least one electronics circuit module can be recharged, inspected, and reintegrated into new airframes for subsequent missions.

In another aspect, an apparatus for manufacturing UAVs or drones from flat sheet stock can comprise a blank feeding system for supplying flat sheet stock blanks for at least a fuselage and a wing; an electronics module feeding system for supplying at least one pre-assembled electronics module; a fuselage forming station configured to form a fuselage blank around the at least one electronics circuit module and bond the blank to retain the at least one electronics circuit module within the formed fuselage; and a wing placement station for positioning and bonding the wing to the fuselage. In one or more aspects, the apparatus can comprise a payload loading station for positioning a payload within or adjacent to the at least one electronics circuit module prior to fuselage forming. The apparatus can comprise a center-of-gravity verification station for confirming that the assembled fuselage with at least one electronics circuit module and payload has a center of gravity within acceptable flight limits. The flat sheet stock blanks can be corrugated paperboard blanks. The fuselage forming station can be a fuselage wrapping station that wraps the fuselage blank around the at least one electronics circuit module and adhesively bonds the blank to itself, retaining the at least one electronics circuit module by friction fit within the wrapped walls. The center-of-gravity verification station can comprise a dual-scale measurement system.

In various aspects, the apparatus can comprise an electronics flight check station configured to verify communication with the flight controller, confirm sensor functionality, test servo actuation of control surfaces, and/or confirm battery charge state. The apparatus can comprise a launch system integrated into the apparatus for deploying flight-ready vehicles directly from the production line. The launch system can be selected from an electronic rail launcher, a capstan launcher, a pneumatic launcher, and/or a robotic arm launcher. The center-of-gravity verification station can divert units failing CG verification for adjustment or rejection. The electronics flight check station can divert units failing flight check for diagnosis. The apparatus can operate at a combined line speed compatible with packaging industry converting rates of hundreds of units per hour. The blank feeding system can supply flat sheet stock blanks for a wing brace, and the wing placement station can further position and bond the wing brace from the underside of the fuselage to the underside of the wing.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims. The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. An unmanned aerial vehicle (UAV) or drone for payload delivery, comprising:
an electronics circuit module comprising a motor, flight controller, and power source;
an airframe formed from flat sheet stock materials including cuttings and pre-formed fold lines, the airframe folded along the fold lines and about the electronics circuit module thereby removably housing the electronics circuit module within a front portion of the airframe; and
a wing assembly affixed to the airframe, the wing assembly comprising a wing formed from flat sheet stock materials;
where the airframe and wing assembly are configured for one-way flight from a launch point to a delivery point.

2. The UAV or drone of claim 1, comprising a tail assembly comprising vertical and horizontal stabilizers formed from flat sheet stock material.

3. The UAV or drone of claim 2, wherein the vertical stabilizer is a fixed vertical stabilizer.

4. The UAV or drone of claim 2, wherein the vertical stabilizer is an extension of the airframe.

5. The UAV or drone of claim 2, comprising a rear electronics circuit module within a rear portion of the airframe, the rear electronics circuit module including servo actuators directly coupled to control surfaces of the vertical and horizontal stabilizers.

6. The UAV or drone of claim 5, wherein the electronics circuit modules are communicatively coupled through a wired connection.

7. The UAV or drone of claim 5, wherein the electronics circuit modules are communicatively coupled through a wireless connection.

8. The UAV or drone of claim 7, wherein the servo actuators comprise a power source.

9. The UAV or drone of claim 1, wherein the electronics circuit module comprises a collapsable propeller.

10. The UAV or drone of claim 1, wherein the flat sheet stock material comprises corrugated paperboard, solid paperboard, corrugated plastic, or foam board.

11. The UAV or drone of claim 10, wherein the flat sheet stock material comprises an environmental protection coating.

12. The UAV or drone of claim 1, wherein the electronics circuit module is secured in the airframe by a friction fit with an internal surface of the folded airframe.

13. The UAV or drone of claim 1, comprising a payload packed in the airframe.

14. A method of delivering a payload, comprising:
erecting an unmanned aerial vehicle (UAV) or drone from flat sheet stock materials including cuttings and pre-formed fold lines by forming an airframe about at least one electronics circuit module, the airframe formed by folding the flat sheet stock material along the fold lines thereby removably housing the at least one electronics circuit module within at least a front portion of the airframe and affixing a wing assembly comprising a wing formed from the flat sheet stock materials to the airframe;
loading a payload into the UAV or drone; and
flying the UAV or drone one-way from a launch point to a delivery point to deliver the payload.

15. The method of claim 14, wherein the UAV or drone arrives at the delivery point via a controlled crash landing, the airframe configured to absorb impact energy through crumple deformation.

16. The method of claim 14, wherein the UAV or drone arrives at the delivery point via parachute deployment.

17. The method of claim 14, wherein the UAV or drone arrives at the delivery point via a tail-sitter approach profile.

18. The method of claim 14, wherein the airframe and wing assembly are disposable or recyclable at the delivery point and the at least one electronics circuit module is returnable to an originator of the payload delivery.

19. The method of claim 14, comprising:
erecting a second UAV or drone from second flat sheet stock materials including cuttings and pre-formed fold lines by forming a second airframe about the at least one electronics circuit module, the second airframe formed by folding the second flat sheet stock material along the fold lines thereby removably housing the at least one electronics circuit module within at least a front portion of the second airframe and affixing a second wing assembly comprising a second wing formed from the second flat sheet stock materials to the airframe;
loading a second payload into the second UAV or drone; and
flying the second UAV or drone one-way from the delivery point to a second delivery point to deliver the second payload.

20. The method of claim 19, wherein the second delivery point is the launch point.
